(19) United States
(12) Patent Application Publication
(10) Pub. No.: US 2025/0118501 A1
(43) Pub. Date: Apr. 10, 2025

(54) MICRO-ELECTROMECHANICAL SYSTEMS SWITCH WITH BEAM MOVEMENT ORTHOGONAL TO FORCE

(71) Applicant: Raytheon Company, Waltham, MA (US)

(72) Inventor: Bahram Ghodsian, San Diego, CA (US)

(73) Assignee: Raytheon Company, Waltham, MA (US)

(21) Appl. No.: 18/483,892

(22) Filed: Oct. 10, 2023

(51) Int. Cl. H01H 1/00; H01H 1/06; H01H 11/00

(52) U.S. Cl. CPC H01H 1/0036; H01H 1/06; H01H 11/00

(57) ABSTRACT

A micro-electromechanical systems (MEMS) switch and method of fabricating the same including at least one comb drive having a first input and a second input, at least one conductive beam connected across the at least one comb drive, a first contact, and a second contact, wherein no voltage difference between the first input and the second input does not result in any movement of the MEMS switch, and wherein a voltage difference between the first input and the second input causes an electrostatic force to be generated that causes the at least one conductive beam to move in a direction orthogonal to a direction of the electrostatic force.

### BACKGROUND

A radio frequency (RF) micro-electromechanical systems (MEMS) switch is an electro-mechanical switch (e.g., a relay) fabricated with semiconductor and MEMS microfabrication tools in a clean room facility. The goals for an RF MEMS switch were to miniaturize a conventional electro-mechanical switch, realize functionality of a solid state switch (e.g., a complementary metal oxide semiconductor (CMOS) switch, a bipolar-CMOS (BICMOS) switch, a Silicon-Germanium (SiGe) switch, etc.), and increase frequency of operation. Unfortunately, RF-MEMS switches have not achieved all of these goals.

There are fundamentally two types of MEMS switches, a shunt capacitive contact switch and an ohmic direct current (DC) contact switch. A MEMS ohmic direct current contact switch includes an actuation gap and a contact gap. Issues with the gap include poor RF insolation, poor ohmic contact, limitations on thickness of a cantilever beam, poor power handling, a complex release procedure, difficulty in cleaning under a cantilever beam, and limitations on using wafer level packaging.

### SUMMARY

In accordance with the concepts described herein, exemplary devices and methods provide a MEMS ohmic direct current contact switch where force is applied in one direction and motion of a contact of the MEMS switch is in a direction orthogonal to the direction of the force.

In accordance with the concepts described herein, exemplary devices and methods provide a MEMS switch where an angle of a beam provides motion amplification.

In accordance with the concepts described herein, exemplary devices and methods provide a MEMS switch with reduced off capacitance.

In accordance with the concepts described herein, exemplary devices and methods provide a MEMS switch that eliminates any constraint on thickness of the MEMS switch.

### DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principles of the concepts described herein. Like reference numerals designate corresponding parts throughout the different views. Furthermore, embodiments are illustrated by way of example and not limitation in the figures, in which:

FIGS. 1A and 1B are illustrations of an exemplary MEMS switch with direction of beam movement orthogonal to direction of electrostatic force according to the present disclosure;

FIGS. 2A and 2B are illustrations of an exemplary first alternative MEMS switch with direction of beam movement orthogonal to direction of electrostatic force according to the present disclosure;

FIGS. 3A and 3B are illustrations of an exemplary second alternative MEMS switch with direction of beam movement orthogonal to direction of electrostatic force according to the present disclosure;

FIGS. 4A and 4B are illustrations of an exemplary third alternative MEMS switch with direction of beam movement orthogonal to direction of electrostatic force according to the present disclosure;

FIG. 5 is an illustration of an exemplary fourth alternative MEMS switch with direction of beam movement orthogonal to direction of electrostatic force according to the present disclosure;

FIG. 6 is an illustration of the exemplary fourth alternative MEMS switch that incorporates the MEMS switch of FIG. 5 within a bottom cap semiconductor wafer and a top cap semiconductor wafer according to the present disclosure;

FIG. 7 is an illustration of exemplary contact configurations according to the present disclosure; and

FIG. 8 is a flowchart of an exemplary method of a MEMS switch with direction of beam movement orthogonal to direction of electrostatic force according to the present disclosure.

### DETAILED DESCRIPTION

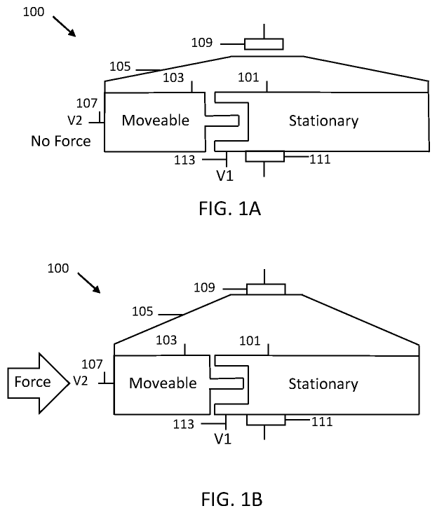

FIGS. 1A and 1B are illustrations of an exemplary MEMS switch 100 with direction of contact movement orthogonal to direction of electrostatic force according to the present disclosure. The MEMS switch 100 comprises a first electrically conductive comb 101, a second electrically conductive comb 103, a conductive beam 105, a first input 113 (e.g., V1), a second input 107 (e.g., V2), a first contact 109, and a second contact 111.

The first electrically conductive comb 101 and the second electrically conductive comb 103 form a comb drive. A comb drive comprises a micro-electromechanical actuator which uses electrostatic forces that act between the first electrically conductive comb 101 and the second electrically conductive comb 103. The first input 113 is connected to the first electrically conductive comb 101 and supplies a voltage (e.g., a positive voltage or a negative voltage) to the first electrically conductive comb 101. The second input 107 is connected to the second electrically conductive comb 103 and supplies a voltage (e.g., a positive voltage or a negative voltage) to the second electrically conductive comb 103.

When voltages supplied by the first input 113 and the second input 107 cause a voltage difference between the first electrically conductive comb 101 and the second electrically conductive comb 103 then an attractive electrostatic force is created between the first electrically conductive comb 101 and the second electrically conductive comb 103, which causes the first electrically conductive comb 101 and the second electrically conductive comb 103 to be physically drawn together. When voltages supplied by the first input 113 and the second input 107 do not cause a voltage difference between the first electrically conductive comb 101 and the second electrically conductive comb 103 then no attractive electrostatic force is created between the first electrically conductive comb 101 and the second electrically conductive comb 103 and the first electrically conductive comb 101 and the second electrically conductive comb 103 are not physically drawn together. The attractive electrostatic force is approximated by Equation (1) as follows:

$$F = ( ϵ ( {hV}^{2} ) ) / g \qquad ( 1 )$$

where F is a driving electrostatic force, E is a dielectric constant of a medium (e.g., air), h is a height of fingers in the comb drive, Vis a voltage difference between the first electrically conductive comb 101 and the second electrically conductive comb 103, and g is distance or gap between the fingers of the first electrically conductive comb 101 and the second electrically conductive comb 103.

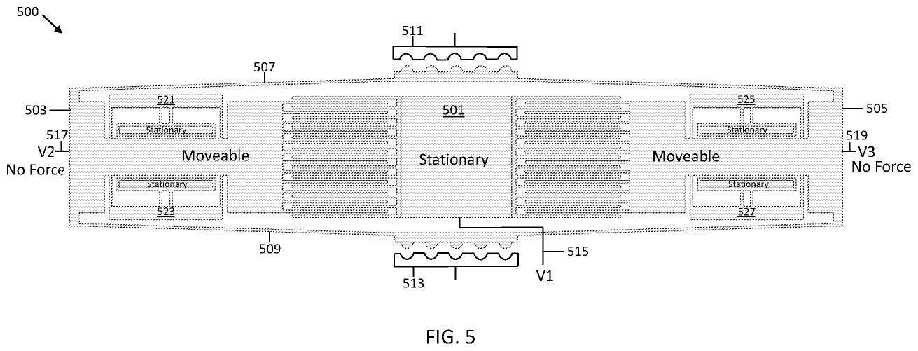

In FIGS. 1A and 1B, the comb drive realized by the first electrically conductive comb 101 and the second electrically conductive comb 103 illustrates one finger. However, the present disclosure is not limited thereto. Each comb drive illustrated in the present disclosure may have more than one finger, where the more than one finger may be interdigitated (e.g., FIG. 5 described below illustrates more than one finger in a comb drive).

FIG. 1A illustrates the MEMS switch 100 when there is no voltage difference between the first electrically conductive comb 101 and the second electrically conductive comb 103. In this state, there is no voltage difference between first input voltage 113 and the second input voltage 107. Thus, the first electrically conductive comb 101 and the second electrically conductive comb 103 are in positions as initially fabricated. In addition, the conductive beam 105, which is connected between the first electrically conductive comb 101 and the second electrically conductive comb 103, is also in a position as initially fabricated (e.g., not in contact with the first contact 109).

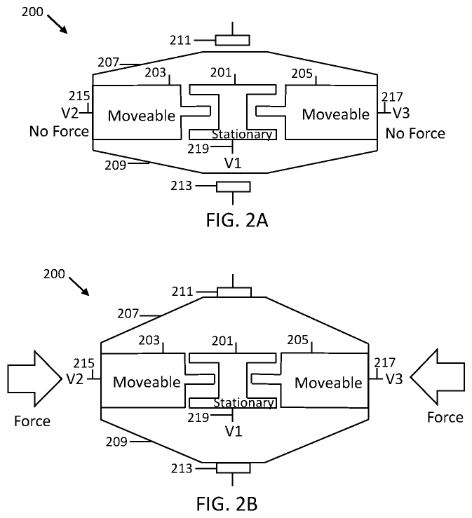

In FIGS. 1A and 1B, the second contact 111 is fixedly connected to the first electrically conductive comb 101. However, the present disclosure is not limited thereto. In other embodiments of the present disclosure, a second contact may not be fixedly connected to a first electrically conductive comb (e.g., see FIGS. 2A, 2B, 4A, 4B, and 5).

In FIGS. 1A and 1B, the first electrically conductive comb 101 is stationary (e.g., anchored in place to not move in the presence of an applied electrostatic force) and the second electrically conductive comb 103 is movable (e.g., not anchored in place but movable in the presence of an applied electrostatic force caused by a voltage difference between the first electrically conductive comb 101 and the second electrically conductive comb 103, where the electrostatic force is inward (e.g., toward the first electrically conductive comb 101). A sufficient voltage difference between the first electrically conductive comb 101 and the second electrically conductive comb 103, as approximated by Equation (1) above, may cause the second electrically conductive comb 103 to move toward the first electrically conductive comb 101 and, thus, cause the conductive beam 105 to move in a direction orthogonal to the direction of the electrostatic force and cause the conductive beam 105 to make contact with the first contact 109. Moving the conductive beam 105 in a direction orthogonal to the direction of the electrostatic force frees the MEMS switch 100 from a gap constraint in the comb drive. The conductive beam 105 may be enabled to move by fabricating the conductive beam 105 in a conventional MEMS fabrication process where material in the direction of movement of the conductive beam 105 may be removed. The first contact 109 and the second contact 111 may each be connected to elements that may be connected by the MEMS switch 100 (e.g., two 5 mm×5 mm patch antennas connected together by the MEMS switch 100 to form one 5 mm×10 mm patch antenna).

The conductive beam 105 may be fabricated to have a user-definable angle. The angle provides motion amplification with an amplification ratio between the motion of the conductive beam 105 and the motion caused by the electrostatic force. The amplification ratio is a ratio of a motion of the conductive beam 105 to a motion caused by the electrostatic force.

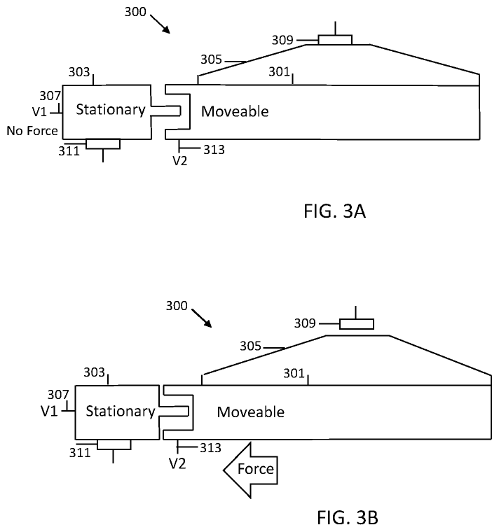

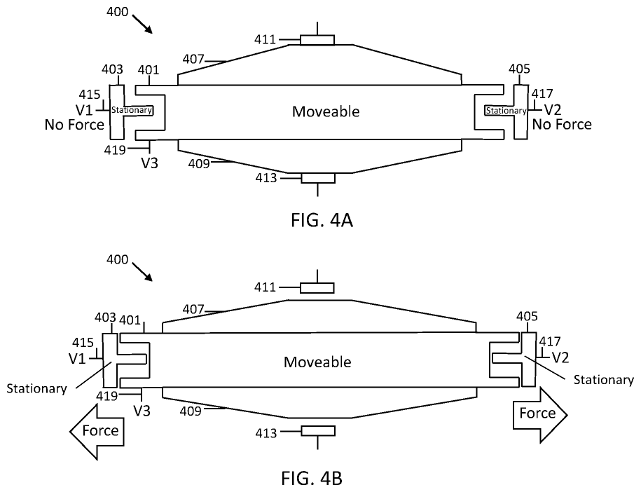

Off capacitance of the MEMS switch 100 is reduced by the first contact 109 being offset from the conductive beam 105. The gap between the first electrically conductive comb 101 and the second electrically conductive comb 103 affects important parameters in the MEMS switch 100 such as actuation voltage. Isolation of the MEMS switch 100 may be increased by moving a contact area of a device to be connected to the MEMS switch 100 away from a contact area of the MEMS switch 100. The present disclosure eliminates gap constraints between the conductive beam 105 and the first contact 109 by a novel principle of operation that enables movement of the conductive beam 105 in a direction orthogonal to a direction of an electrostatic force that moves the comb drive. The present disclosure uses a comb drive to generate an electrostatic force to move a conductive beam. In FIGS. 1A and 1B, the electrostatic force is applied in an inward direction (e.g., in a direction from the movable second electrically conductive comb 103 toward the stationary first electrically conductive comb 101). However, the present disclosure is not limited thereto. The electrostatic force may be applied in an outward direction (e.g., in a direction opposite to the inward direction described above) as illustrated in FIGS. 3B and 4B (e.g., with a different comb drive configuration).

FIGS. 2A and 2B are illustrations of an exemplary first alternative MEMS switch 200 with direction of beam movement orthogonal to direction of electrostatic force according to the present disclosure. The MEMS switch 200 comprises a first electrically conductive comb 201, a second electrically conductive comb 203, a third electrically conductive comb 205, a first conductive beam 207, a second conductive beam 209, a first input 219 (e.g., V1), a second input 215 (e.g., V2), a third input 217 (e.g., V3), a first contact 211, and a second contact 213.

The first electrically conductive comb 201, the second electrically conductive comb 203, and the third electrically conductive comb 205 form two back-to-back comb drives that share the first electrically conductive comb 201. The two back-to-back comb drives comprise two micro-electromechanical actuators which use electrostatic forces that act in a first comb drive between the first electrically conductive comb 201 and the second electrically conductive comb 203 and a second comb drive between the first electrically conductive comb 201 and the third electrically conductive comb 205. The first input 219 is connected to the first electrically conductive comb 201 and supplies a voltage (e.g., a positive voltage or a negative voltage) to the first electrically conductive comb 201. The second input 215 is connected to the second electrically conductive comb 203 and supplies a voltage (e.g., a positive voltage or a negative voltage) to the second electrically conductive comb 203. The third input 217 is connected to the third electrically conductive comb 205 and supplies a voltage (e.g., a positive voltage or a negative voltage) to the third electrically conductive comb 205. When the voltages on the second input 215 and the third input 217 are the same and different from the voltage on the first input 219 the electrostatic forces generated by the first comb drive and the second comb drive will be the same but in opposite directions (e.g., both inward toward the first electrically conductive comb 201, because the first electrically conductive comb 201 is stationary (e.g., anchored) and the second electrically conductive comb 203 and the third electrically conductive comb 205 are both movable). However, the voltages on the second input 215 and the third input 217 may be different from each other and different from the voltage on the first input 219. In this case, the electrostatic forces generated by the first comb drive and the second comb drive will be different according to Equation (1) above.

When voltages supplied by the first input 219, the second input 215, and the third input 217 cause a voltage difference between the first electrically conductive comb 201 and each of the second electrically conductive comb 203 and the third electrically conductive comb 205 then an attractive electrostatic force is created between the first electrically conductive comb 201 and each of the second electrically conductive comb 203 and the third electrically conductive comb 205, which cause the second electrically conductive comb 103 and the third electrically conductive comb 205 to each be drawn toward the first electrically conductive comb 201. When voltages supplied by the first input 219, the second input 215, and the third input 217 do not cause a voltage difference between the first electrically conductive comb 201 and either of the second electrically conductive comb 203 and the third electrically conductive comb 205 then no attractive electrostatic force is created between the first electrically conductive comb 201 and either of the second electrically conductive comb 203 and the third electrically conductive comb 205 and neither of the second electrically conductive comb 203 nor the third electrically conductive comb 205 are physically drawn toward the first electrically conductive comb 201. The attractive electrostatic force is approximated by Equation (1) above.

In FIGS. 2A and 2B, the two comb drives realized by the first electrically conductive comb 201, the second electrically conductive comb 203, and the third electrically conductive comb 205 illustrate two comb drives each with one finger. However, the present disclosure is not limited thereto. Each comb drive illustrated in the present disclosure may have more than one finger, where the more than one finger may be interdigitated (e.g., FIG. 5 described below illustrates more than one finger in a comb drive).

FIG. 2A illustrates the MEMS switch 200 when there is no voltage difference between the first electrically conductive comb 201 and either of the second electrically conductive comb 203 or the third electrically conductive comb 205. In this state, there is no voltage difference between the first input voltage 219 and either the second input voltage 215 or the third input voltage 217. Thus, the first electrically conductive comb 201, the second electrically conductive comb 203, and the third electrically conductive comb 205 are in positions as initially fabricated. In addition, the first conductive beam 207 and the second conductive beam 209, which are each connected between the second electrically conductive comb 203 and the third electrically conductive comb 205, but on opposite sides of the second electrically conductive comb 203 and the third electrically conductive comb 205, respectively, are also in positions as initially fabricated (e.g., not in contact with the first contact 211 and the second contact 213, respectively).

In FIGS. 2A and 2B, the first electrically conductive comb 201 is stationary (e.g., anchored in place to not move in the presence of an applied electrostatic force) and the second electrically conductive comb 203 and the third electrically conductive comb 205 are movable (e.g., not anchored in place but movable in the presence of an applied electrostatic force caused by a voltage difference between the first electrically conductive comb 201 and each of the second electrically conductive comb 203 and the third electrically conductive comb 205, respectively, where the two electrostatic forces are inward (e.g., toward the first electrically conductive comb 201). A sufficient voltage difference between the first electrically conductive comb 201 and each of the second electrically conductive comb 203 and the third electrically conductive comb 205, as approximated by Equation (1) above, may cause each of the second electrically conductive comb 203 and the third electrically conductive comb 205 to move toward the first electrically conductive comb 201, respectively, and, thus, cause each of the first beam 207 and the second beam 209 to move in a direction orthogonal to the direction of the electrostatic forces and cause the first conductive beam 207 to make contact with the first contact 211 and the second conductive beam 209 to make contact with the second contact 213. Moving the first conductive beam 207 and the second conductive beam 209 in directions orthogonal to the directions of the electrostatic forces frees the MEMS switch 200 from gap constraints in the comb drives. The first conductive beam 207 and the second conductive beam 209 may be enabled to move by fabricating the first conductive beam 207 and the second conductive beam 209 in a conventional MEMS fabrication process where material in the direction of movement of the first conductive beam 207 and the second conductive beam 209 may be removed. The first contact 211 and the second contact 213 may each be connected to elements that may be connected by the MEMS switch 200.

The first conductive beam 207 and the second conductive beam 209 are each fabricated to have a user-definable angle. Each angle provides motion amplification with an amplification ratio between the motion of the corresponding beam (e.g., the first conductive beam 207 or the second conductive beam 209) and the motion that moves the corresponding beam that is caused by a corresponding electrostatic force. The amplification ratio of a beam is a ratio of a motion of the beam to a motion caused by the electrostatic force that moves the beam.

Off capacitance of the MEMS switch 200 is reduced by the first contact 211 and the second contact 213 each being orthogonal to the first conductive beam 207 and the second conductive beam 209, respectively. The gaps between the first electrically conductive comb 201 and each of the second electrically conductive comb 203 and the third electrically conductive comb 205, respectively, affect important parameters in the MEMS switch 200 such as actuation voltage. Isolation of the MEMS switch 200 may be increased by moving a contact area of a device to be connected to the MEMS switch 200 away from a contact area of the MEMS switch 200. The present disclosure eliminates gap constraints between (1) the first conductive beam 207 and the first contact 211 and (2) the second conductive beam 209 and the second contact 213 by a novel principle of operation that enables movement of the first conductive beam 207 and the second conductive beam 209 in directions orthogonal to directions of electrostatic forces that move the first conductive beam 207 and the second conductive beam 209, respectively. The present disclosure uses comb-drive to generate a force to move a beam. In FIGS. 2A and 2B, the directions of the electrostatic forces are applied inward toward the first electrically conductive comb 201. However, the present disclosure is not limited thereto. The directions of the electrostatic forces may be applied outward from the first electrically conductive comb 201 as illustrated in FIGS. 3B and 4B.

FIGS. 3A and 3B are illustrations of an exemplary second alternative MEMS switch 300 with direction of beam movement orthogonal to direction of electrostatic force according to the present disclosure. The MEMS switch 300 comprises a first electrically conductive comb 301, a second electrically conductive comb 303, a conductive beam 305, a first input 307 (e.g., V1), a second input 313 (e.g., V2), a first contact 311, and a second contact 309.

The first electrically conductive comb 301 and the second electrically conductive comb 303 form a comb drive. A comb drive comprises a micro-electromechanical actuator which uses electrostatic forces that act between the first electrically conductive comb 301 and the second electrically conductive comb 303. The first input 307 is connected to the second electrically conductive comb 303 and supplies a voltage (e.g., a positive voltage or a negative voltage) to the second electrically conductive comb 303. The second input 313 is connected to the first electrically conductive comb 301 and supplies a voltage (e.g., a positive voltage or a negative voltage) to the first electrically conductive comb 301.

When voltages supplied by the first input 307 and the second input 313 cause a voltage difference between the first electrically conductive comb 301 and the second electrically conductive comb 303 then an attractive electrostatic force is created between the first electrically conductive comb 301 and the second electrically conductive comb 303, which causes the first electrically conductive comb 301 and the second electrically conductive comb 303 to be physically drawn together. When voltages supplied by the first input 307 and the second input 313 do not cause a voltage difference between the first electrically conductive comb 301 and the second electrically conductive comb 303 then no attractive electrostatic force is created between the first electrically conductive comb 301 and the second electrically conductive comb 303 and the first electrically conductive comb 301 and the second electrically conductive comb 303 are not physically drawn together. The attractive electrostatic force is approximated by Equation (1) above.

In FIGS. 3A and 3B, the comb drive realized by the first electrically conductive comb 301 and the second electrically conductive comb 303 illustrates one finger. However, the present disclosure is not limited thereto. Each comb drive illustrated in the present disclosure may have more than one finger, where the more than one finger may be interdigitated (e.g., FIG. 5 described below illustrates more than one finger in a comb drive).

FIG. 3A illustrates the MEMS switch 300 when there is no voltage difference between the first electrically conductive comb 301 and the second electrically conductive comb 303. In this state, there is no voltage difference between first input voltage 307 and the second input voltage 313. Thus, the first electrically conductive comb 301 and the second electrically conductive comb 303 are in positions as initially fabricated. In addition, the conductive beam 305, which is connected between the first electrically conductive comb 301 and the second electrically conductive comb 303, is also in a position as initially fabricated (e.g., in contact with the first contact 311).

In FIGS. 3A and 3B, the first electrically conductive comb 301 is movable (e.g., not anchored in place so as to move in the presence of an applied electrostatic force caused by a voltage difference between the first electrically conductive comb 301 and the second electrically conductive comb 303, where the electrostatic force is away from the first electrically conductive comb 301 (e.g., outward) and toward the second electrically conductive comb 303) and the second electrically conductive comb 303 is stationary (e.g., anchored in place so as to not move in the presence of an applied electrostatic force). A sufficient voltage difference between the first electrically conductive comb 301 and the second electrically conductive comb 303, as approximated by Equation (1) above, may cause the first electrically conductive comb 301 to move toward the second electrically conductive comb 303 and, thus, cause the conductive beam 305 to move in a direction orthogonal to the direction of the electrostatic force and cause the conductive beam 305 to disconnect from the first contact 309. Moving the conductive beam 305 in a direction orthogonal to the direction of the electrostatic force frees the MEMS switch 300 from a gap constraint on the comb drive. The conductive beam 305 may be enabled to move by fabricating the conductive beam 305 in a conventional MEMS fabrication process where material in the direction of movement of the conductive beam 305 may be removed. The first contact 311 and the second contact 309 may each be connected to elements that may be connected by the MEMS switch 300.

The conductive beam 305 may be fabricated to have a user-definable angle. The angle provides motion amplification with an amplification ratio between the motion of the corresponding beam and the motion caused by the corresponding electrostatic force. The amplification ratio is a ratio of a motion of the conductive beam 305 to a motion caused by the electrostatic force.

Off capacitance of the MEMS switch 300 is reduced by the second contact 309 being offset from the conductive beam 305. The gap between the first electrically conductive comb 301 and the second electrically conductive comb 303 affects important parameters in the MEMS switch 300 such as actuation voltage. Isolation of the MEMS switch 300 may be increased by moving a contact area of a device to be connected to the MEMS switch 300 away from a contact area of the MEMS switch 300. The present disclosure eliminates gap constraints between the conductive beam 305 and the second contact 309 by a novel principle of operation that enables movement of the conductive beam 305 in a direction orthogonal to a direction of an electrostatic force. The present disclosure uses comb-drive to generate a force to move a beam. In FIGS. 3A and 3B, the electrostatic force is applied in an outward direction (e.g., away from the first electrically conductive comb 301 and toward the second electrically conductive comb 303). However, the present disclosure is not limited thereto. The electrostatic force may be applied in an inward direction as illustrated in FIGS. 1B and 2B.

FIGS. 4A and 4B are illustrations of an exemplary third alternative MEMS switch 400 with direction of beam movement orthogonal to direction of electrostatic force according to the present disclosure. The MEMS switch 400 comprises a first electrically conductive comb 401, a second electrically conductive comb 403, a third electrically conductive comb 405, a first conductive beam 407, a second conductive beam 409, a first input 415 (e.g., V1), a second input 417 (e.g., V2), a third input 419 (e.g., V3), a first contact 411, a second contact 413.

The first electrically conductive comb 401, the second electrically conductive comb 403, and the third electrically conductive comb 405 form two back-to-back comb drives that share the first electrically conductive comb 401. The two back-to-back comb drives comprise two micro-electromechanical actuators which use electrostatic forces that act in a first comb drive between the first electrically conductive comb 401 and the second electrically conductive comb 403 and a second comb drive between the first electrically conductive comb 401 and the third electrically conductive comb 405. The third input 419 is connected to the first electrically conductive comb 401 and supplies a voltage (e.g., a positive voltage or a negative voltage) to the first electrically conductive comb 401. The first input 415 is connected to the second electrically conductive comb 403 and supplies a voltage (e.g., a positive voltage or a negative voltage) to the second electrically conductive comb 403. The third input 417 is connected to the third electrically conductive comb 405 and supplies a voltage (e.g., a positive voltage or a negative voltage) to the third electrically conductive comb 405. When the voltages on the first input 415 and the third input 417 are the same and different from the voltage on the third input 419 the electrostatic forces generated by the first comb drive and the second comb drive will be the same but in opposite directions (e.g., both outward and away from the first electrically conductive comb 401 and toward the second electrically conductive comb 403 and the third electrically conductive comb 405, because the first electrically conductive comb 401 is movable (e.g., not anchored) and the second electrically conductive comb 403 and the third electrically conductive comb 405 are both stationary (e.g., anchored)). However, the voltages on the first input 415 and the third input 417 may be different from each other and different from the voltage on the third input 419. In this case, the electrostatic forces generated by the first comb drive and the second comb drive will be different according to Equation (1) above.

When voltages supplied by the first input 415, the second input 417, and the third input 419 cause a voltage difference between the first electrically conductive comb 401 and each of the second electrically conductive comb 403 and the third electrically conductive comb 405 then an attractive electrostatic force is created between the first electrically conductive comb 401 and each of the second electrically conductive comb 403 and the third electrically conductive comb 405, which cause the first electrically conductive comb 401 to be drawn toward each of the second electrically conductive comb 403 and the third electrically conductive comb 405. When voltages supplied by the first input 415, the second input 417, and the third input 419 do not cause a voltage difference between the first electrically conductive comb 401 and either of the second electrically conductive comb 403 and the third electrically conductive comb 405 then no attractive electrostatic force is created between the first electrically conductive comb 401 and either of the second electrically conductive comb 403 and the third electrically conductive comb 405 and the first electrically conductive comb 401 is not physically drawn toward either of the second electrically conductive comb 403 or the third electrically conductive comb 405. The attractive electrostatic force is approximated by Equation (1) above.

In FIGS. 4A and 4B, the two comb drives realized by the first electrically conductive comb 401, the second electrically conductive comb 403, and the third electrically conductive comb 405 illustrate two comb drives each with one finger. However, the present disclosure is not limited thereto. Each comb drive illustrated in the present disclosure may have more than one finger, where the more than one finger may be interdigitated (e.g., FIG. 5 described below illustrates more than one finger in a comb drive).

FIG. 4A illustrates the MEMS switch 400 when there is no voltage difference between the first electrically conductive comb 401 and either of the second electrically conductive comb 403 or the third electrically conductive comb 405. In this state, there is no voltage difference between first input voltage 415 and either the second input voltage 417 or the third input voltage 419. Thus, the first electrically conductive comb 401, the second electrically conductive comb 403, and the third electrically conductive comb 405 are in positions as initially fabricated. In addition, the first conductive beam 407 and the second conductive beam 409, which are each connected between opposite ends of the first electrically conductive comb 401, but on opposite sides of the first electrically conductive comb 401, respectively, are also in positions as initially fabricated (e.g., in contact with the first contact 411 and the second contact 413, respectively).

In FIGS. 4A and 4B, the first electrically conductive comb 401 is movable (e.g., not anchored in place so as to move in the presence of an applied electrostatic force caused by a voltage difference between the first electrically conductive comb 401 and each of the second electrically conductive comb 403 and the third electrically conductive comb 405, respectively, where the two electrostatic forces are outward (e.g., away from the first electrically conductive comb 401 and toward each of the second electrically conductive comb 403 and the third electrically conductive comb 405)) and the second electrically conductive comb 403 and the third electrically conductive comb 405 are stationary (e.g., anchored in place to not move in the presence of an applied electrostatic force). A sufficient voltage difference between the first electrically conductive comb 401 and each of the second electrically conductive comb 403 and the third electrically conductive comb 405, as approximated by Equation (1) above, may cause the first electrically conductive comb 401 to move toward each of the second electrically conductive comb 403 and the third electrically conductive comb 405, respectively, and, thus, cause each of the first conductive beam 407 and the second conductive beam 409 to move in a direction orthogonal to the direction of the electrostatic forces and cause the first conductive beam 407 to disconnect from the first contact 411 and the second conductive beam 409 to disconnect from the second contact 413. Moving the first conductive beam 407 and the second conductive beam 409 in directions orthogonal to the directions of the electrostatic forces frees the MEMS switch 400 from gap constraints on the comb drives. The first conductive beam 407 and the second conductive beam 409 may be enabled to move by fabricating the first conductive beam 407 and the second conductive beam 409 in a conventional MEMS fabrication process where material in the direction of movement of the first conductive beam 407 and the second conductive beam 409 may be removed. The first contact 411 and the second contact 413 may each be connected to elements that may be connected by the MEMS switch 400.

The first conductive beam 407 and the second conductive beam 409 are each fabricated to have a user-definable angle with a side of the first electrically conductive comb 401 to which the first conductive beam 407 and the second conductive beam 409 are attached, respectively. Each angle provides motion amplification with an amplification ratio between the motion of the corresponding beam (e.g., the first conductive beam 407 or the second conductive beam 409) and the motion that moves the corresponding beam that is caused by a corresponding electrostatic force. The amplification ratio of a beam is a ratio of a motion of the beam to a motion caused by the electrostatic force that moves the beam.

Off capacitance of the MEMS switch 400 is reduced by the first contact 411 and the second contact 413 each being offset from the first conductive beam 407 and the second conductive beam 409, respectively. The gaps between the first electrically conductive comb 401 and each of the second electrically conductive comb 403 and the third electrically conductive comb 405, respectively, affect important parameters in the MEMS switch 400 such as actuation voltage. Isolation of the MEMS switch 400 may be increased by moving a contact area of a device to be connected to the MEMS switch 400 away from a contact area of the MEMS switch 200. The present disclosure eliminates gap constraints between (1) the first conductive beam 407 and the first contact 411 and (2) the second conductive beam 409 and the second contact 413 by a novel principle of operation that enables movement of the first conductive beam 407 and the second conductive beam 409 in directions orthogonal to directions of electrostatic forces that move the first conductive beam 407 and the second conductive beam 409, respectively. The present disclosure uses comb-drive to generate a force to move a conductive beam. In FIGS. 4A and 4B, the directions of the electrostatic forces are applied outward and away from the first electrically conductive comb 401 and towards each of the second electrically conductive comb 403 and the third electrically conductive comb 405. However, the present disclosure is not limited thereto. The directions of the electrostatic forces may be applied inward toward the first electrically conductive comb 401 as illustrated in FIGS. 1B and 2B.

FIG. 5 is an illustration of an exemplary fourth alternative MEMS switch 500 with direction of beam movement orthogonal to direction of electrostatic force according to the present disclosure. The MEMS switch 500 comprises a first electrically conductive comb 501, a second electrically conductive comb 503, a third electrically conductive comb 505, a first conductive beam 507, a second conductive beam 509, a first input 515 (e.g., V1), a second input 517 (e.g., V2), a third input 519 (e.g., V3), a first contact 511, a second contact 513, a first anchor 521, a second anchor 523, a third anchor 525, and a fourth anchor 527.

The first electrically conductive comb 501, the second electrically conductive comb 503, and the third electrically conductive comb 505 form two back-to-back comb drives that share the first electrically conductive comb 501. The two back-to-back comb drives comprise two micro-electromechanical actuators which use electrostatic forces that act in a first comb drive between the first electrically conductive comb 501 and the second electrically conductive comb 503 and a second comb drive between the first electrically conductive comb 501 and the third electrically conductive comb 505. The first input 515 is connected to the first electrically conductive comb 501 and supplies a voltage (e.g., a positive voltage or a negative voltage) to the first electrically conductive comb 501. The second input 517 is connected to the second electrically conductive comb 503 and supplies a voltage (e.g., a positive voltage or a negative voltage) to the second electrically conductive comb 503. The third input 519 is connected to the third electrically conductive comb 505 and supplies a voltage (e.g., a positive voltage or a negative voltage) to the third electrically conductive comb 505. When the voltages on the second input 517 and the third input 519 are the same and different from the voltage on the first input 515 the electrostatic forces generated by the first comb drive and the second comb drive will be the same but in opposite directions (e.g., both inward toward the first electrically conductive comb 501, because the first electrically conductive comb 501 is stationary (e.g., anchored) and the second electrically conductive comb 503 and the third electrically conductive comb 505 are both movable). However, the voltages on the second input 517 and the third input 519 may be different from each other and different from the voltage on the first input 515. In this case, the electrostatic forces generated by the first comb drive and the second comb drive will be different according to Equation (1) above.

When voltages supplied by the first input 515, the second input 517, and the third input 519 cause a voltage difference between the first electrically conductive comb 501 and each of the second electrically conductive comb 503 and the third electrically conductive comb 505 then an attractive electrostatic force is created between the first electrically conductive comb 501 and each of the second electrically conductive comb 503 and the third electrically conductive comb 505, which cause the second electrically conductive comb 503 and the third electrically conductive comb 505 to each be drawn toward the first electrically conductive comb 501 similarly as illustrated in FIG. 2B and described above in greater detail. When voltages supplied by the first input 515, the second input 517, and the third input 519 do not cause a voltage difference between the first electrically conductive comb 501 and either of the second electrically conductive comb 503 and the third electrically conductive comb 505 then no attractive electrostatic force is created between the first electrically conductive comb 501 and either of the second electrically conductive comb 503 and the third electrically conductive comb 505 and neither of the second electrically conductive comb 503 nor the third electrically conductive comb 505 are physically drawn toward the first electrically conductive comb 501. The attractive electrostatic force is approximated by Equation (1) above.

In FIG. 5, the two comb drives realized by the first electrically conductive comb 501, the second electrically conductive comb 503, and the third electrically conductive comb 505 illustrate two comb drives each with more than one interdigitated finger. However, the present disclosure is not limited thereto. Each comb drive illustrated in the present disclosure may have as few as one finger (e.g., FIGS. 1A, 1B, 2A, 2B, 3A, 3B, 4A, and 4B described above illustrate one finger in a comb drive).

FIG. 5 illustrates the MEMS switch 500 when there is no voltage difference between the first electrically conductive comb 501 and either of the second electrically conductive comb 503 or the third electrically conductive comb 505. In this state, there is no voltage difference between first input voltage 515 and either the second input voltage 517 or the third input voltage 519. Thus, the first electrically conductive comb 501, the second electrically conductive comb 503, and the third electrically conductive comb 505 are in positions as initially fabricated. In addition, the first conductive beam 507 and the second conductive beam 509, which are each connected between the second electrically conductive comb 503 and the third electrically conductive comb 505, but on opposite sides of the second electrically conductive comb 503 and the third electrically conductive comb 505, respectively, are also in positions as initially fabricated (e.g., not in contact with the first contact 511 and the second contact 513, respectively).

In FIG. 5, the first electrically conductive comb 501 is stationary (e.g., anchored in place to not move in the presence of an applied electrostatic force) and the second electrically conductive comb 503 and the third electrically conductive comb 505 are movable (e.g., not anchored in place but movable in the presence of an applied electrostatic force caused by a voltage difference between the first electrically conductive comb 501 and each of the second electrically conductive comb 503 and the third electrically conductive comb 505, respectively, where the two electrostatic forces are inward (e.g., toward the first electrically conductive comb 501). A sufficient voltage difference between the first electrically conductive comb 501 and each of the second electrically conductive comb 503 and the third electrically conductive comb 505, as approximated by Equation (1) above, may cause each of the second electrically conductive comb 503 and the third electrically conductive comb 505 to move toward the first electrically conductive comb 501, respectively, and, thus, cause each of the first conductive beam 507 and the second conductive beam 509 to move in a direction orthogonal to the direction of the electrostatic forces and cause the first conductive beam 507 to make contact with the first contact 511 and the second conductive beam 509 to make contact with the second contact 513. Moving the first conductive beam 507 and the second conductive beam 509 in directions orthogonal to the directions of the electrostatic forces frees the MEMS switch 500 from gap constraints in the comb drives. The first conductive beam 507 and the second conductive beam 509 may be enabled to move by fabricating the first conductive beam 507 and the second conductive beam 509 in a conventional MEMS fabrication process where material in the direction of movement of the first conductive beam 507 and the second conductive beam 509 may be removed. The first contact 511 and the second contact 513 may each be connected to elements that may be connected by the MEMS switch 500.

In FIG. 5, the first anchor 521 and the third anchor 525 are placed on one side of the second electrically conductive comb 503 and the third electrically conductive comb 505, respectively, to restrict movement of the first conductive beam 507 in one axis (e.g., orthogonal to the direction of the electrostatic forces). The second anchor 523 and the fourth anchor 527 are placed on the other side of the second electrically conductive comb 503 and the third electrically conductive comb 505, respectively, to restrict movement of the second conductive beam 509 in one axis (e.g., orthogonal to the direction of the electrostatic forces).

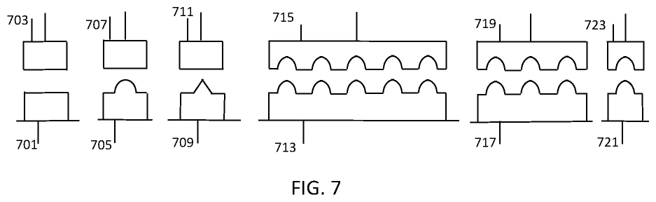

In FIG. 5, the first contact 511 and the second contact 513 are each shaped to include more than one recess to improve contact with the first conductive beam 507 and the second conductive beam 509, respectively, where the first conductive beam 507 and the second conductive beam 509 include complimentary structures to fit into the first contact 511 and the second contact 513, respectively. However, the present disclosure is not limited to contact with at least one recess as illustrated in FIG. 7 and described below in greater detail.

The first conductive beam 507 and the second conductive beam 509 are each fabricated to have a user-definable angle. Each angle provides motion amplification with an amplification ratio between the motion of the corresponding beam (e.g., the first conductive beam 507 or the second conductive beam 509) and the motion that moves the corresponding beam that is caused by a corresponding electrostatic force. The amplification ratio of a beam is a ratio of a motion of the beam to a motion caused by the electrostatic force that moves the beam.

Off capacitance of the MEMS switch 500 is reduced by the first contact 511 and the second contact 513 each being offset from the first conductive beam 507 and the second conductive beam 509, respectively. The gaps between the first electrically conductive comb 501 and each of the second electrically conductive comb 503 and the third electrically conductive comb 505, respectively, affect important parameters in the MEMS switch 500 such as actuation voltage. Isolation of the MEMS switch 500 may be increased by moving a contact area of a device to be connected to the MEMS switch 500 away from a contact area of the MEMS switch 500. The present disclosure eliminates gap constraints between (1) the first conductive beam 507 and the first contact 511 and (2) the second conductive beam 509 and the second contact 513 by a novel principle of operation that enables movement of the first conductive beam 507 and the second conductive beam 509 in directions orthogonal to directions of electrostatic forces that move the first conductive beam 507 and the second conductive beam 509, respectively. The present disclosure uses comb-drive to generate a force to move a beam. In FIG. 5, the directions of the electrostatic forces are applied inward toward the first electrically conductive comb 501. However, the present disclosure is not limited thereto. The directions of the electrostatic forces may be applied outward from the first electrically conductive comb 501 as illustrated in FIGS. 3B and 4B.

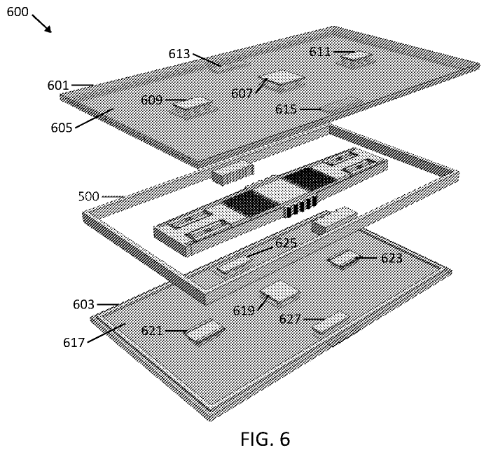

FIG. 6 is an illustration of the exemplary fourth alternative MEMS switch 600 that incorporates the MEMS switch 500 of FIG. 5 on a bottom cap semiconductor wafer 603 with a top cap semiconductor wafer 601 on the MEMS switch 500 according to the present disclosure. The top cap semiconductor wafer 601 comprises a first semiconductor substrate 605, a first pedestal 607 on a bottom of the first semiconductor substrate 605 for supporting a top of the first electrically conductive comb 501 of the MEMS switch 500, a second pedestal 609 on the bottom of the first semiconductor substrate 605 for supporting a top of the second electrically conductive comb 503 of the MEMs switch 500, a third pedestal 611 on the bottom of the first semiconductor substrate 605 for supporting a top of the third electrically conductive comb 505 of the MEMS switch 500, a fourth pedestal 613 on the bottom of the first semiconductor substrate 605 for supporting a top of the first contact 511 of the MEMS switch 500, and a fifth pedestal 615 on the bottom of the first semiconductor substrate 605 for supporting a top of the second contact 511 of the MEMS switch 500. The bottom cap semiconductor wafer 603 on which the MEMS switch 500 is fabricated comprises a second semiconductor substrate 617, a sixth pedestal 619 on a top of the second semiconductor substrate 617 for supporting a bottom of the first electrically conductive comb 501 of the MEMS switch 500, a seventh pedestal 621 on the top of the second semiconductor substrate 617 for supporting a bottom of the second electrically conductive comb 503 of the MEMs switch 500, a third pedestal 623 on the top of the second semiconductor substrate 617 for supporting a bottom of the third electrically conductive comb 505 of the MEMS switch 500, a fourth pedestal 625 on the top of the second semiconductor substrate 617 for supporting a bottom of the first contact 511 of the MEMS switch 500, and a fifth pedestal 627 on the top of the second semiconductor substrate 617 for supporting a bottom of the second contact 511 of the MEMS switch 500.

FIG. 7 is an illustration of exemplary contact configurations according to the present disclosure. In a first configuration, a conductive beam 701 comprises a flat surface facing a contact 703, where the contact 703 has a flat surface facing the conductive beam 701. In a second configuration, a conductive beam 705 comprises a raised and rounded surface facing a contact 707, where the contact 707 has a flat surface facing the conductive beam 705. In a third configuration, a conductive beam 709 comprises a raised and pointed surface facing a contact 711, where the contact 711 has a flat surface facing the conductive beam 709. In a fourth configuration, a conductive beam 713 comprises multiple raised and rounded surfaces (e.g., 5) facing a contact 715, where the contact 715 has multiple recessed and rounded surfaces (e.g., 5) facing the conductive beam 713 that receives the multiple raised and rounded surfaces of the conductive beam 713, respectively. In a fifth configuration, a conductive beam 717 comprises multiple raised and rounded surfaces (e.g., 3) facing a contact 719, where the contact 719 has multiple recessed and rounded surfaces (e.g., 3) facing the conductive beam 717 that receives the multiple raised and rounded surfaces of the conductive beam 717, respectively. In a sixth configuration, a conductive beam 721 comprises one raised and rounded surface facing a contact 723, where the contact 723 has one recessed and rounded surface facing the conductive beam 721 that receives the one raised and rounded surface of the conductive beam 721.

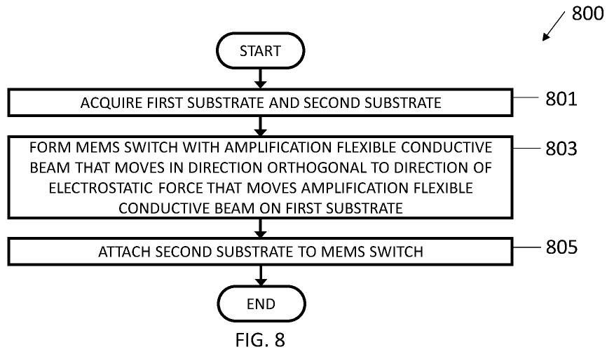

FIG. 8 is a flowchart of an exemplary method 800 of a MEMS switch with direction of beam movement orthogonal to direction of electrostatic force according to the present disclosure. Step 801 of the method 800 comprises acquiring a first substrate (e.g., a bottom cap wafer) and a second substrate (e.g., a top cap wafer). Step 803 of the method 800 comprises forming a MEMS switch with an amplification flexible conductive beam that moves in a direction orthogonal to a direction of electrostatic force that moves the amplification flexible conductive beam on the first substrate. Step 805 of the method 800 comprises attaching the second substrate to the MEMS switch. The MEMS switch may comprise Silicon (e.g., CMOS, Bipolar, BiCMOS, etc.), Gallium Arsenide (GaAs), Germanium (Ge), Silicon Germanium (SiGe), Gallium Phosphide (GaP), or quartz. The first substrate and the second substrate may each comprise Silicon (e.g., CMOS, Bipolar, BiCMOS, Indium Phosphide (InP), Lithium Niobate (LiNbO₃), etc.), Gallium Arsenide (GaAs), Germanium (Ge), Silicon Germanium (SiGe), Gallium Phosphide (GaP), quartz, glass, borosilicate glass, fused glass, photo-structurable glass, alumina, Gallium Nitride (GaN), a printed circuit board (PCB), Sapphire, Silicon Carbide, Aluminum Nitride (AlN), Silicon-On-Insulator (SOI), Silicon-on-Sapphire (SOS), Germanium-on-Silicon, Lithium Tantalate, Zinc Oxide, or photo definable glass. Electrically conductive combs of the present disclosure may also comprise a piezoelectric device, an electro-magnet, and/or a thermal actuator.

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims.

Various embodiments of the concepts, systems, devices, structures and techniques sought to be protected are described herein with reference to the related drawings. Alternative embodiments can be devised without departing from the scope of the concepts, systems, devices, structures and techniques described herein.

It is noted that various connections and positional relationships (e.g., over, below, adjacent, etc.) are set forth between elements in the above description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “at least one” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description herein, terms such as “upper,” “lower,” “right,” “left,” “vertical,” “horizontal, “top,” “bottom,” (to name but a few examples) and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements. Such terms are sometimes referred to as directional or positional terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within +20% of a target value in some embodiments, within ±10% of a target value in some embodiments, within ±5% of a target value in some embodiments, and yet within +2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A micro-electromechanical systems (MEMS) switch, comprising:
at least one comb drive having a first input and a second input,
at least one conductive beam connected across the at least one comb drive;
a first contact; and
a second contact,
wherein no voltage difference between the first input and the second input does not result in any movement of the MEMS switch, and
wherein a voltage difference between the first input and the second input causes an electrostatic force to be generated that causes the at least one conductive beam to move in a direction orthogonal to a direction of the electrostatic force.

2. The MEMS switch of claim 1, wherein the at least one comb drive comprises a stationary first electrically conductive comb having at least one comb finger and a movable second electrically conductive comb having at least one comb finger;
wherein the at least one conductive beam comprises one conductive beam connected between the stationary first electrically conductive comb and the movable second electrically conductive comb;
wherein the second contact is fixedly connected to the stationary first electrically conductive comb;
wherein the first contact is not in contact with the one conductive beam when there is no voltage difference between the first input and the second input; and
wherein the first input is connected to the stationary first electrically conductive comb and the second input is connected to the movable second electrically conductive comb such that the voltage difference between the first input and the second input causes, by the generated electromagnetic force, the movable second electrically conductive comb to be physically drawn inward toward the stationary first electrically conductive comb and causes the one conductive beam to contact the first contact.

3. The MEMS switch of claim 1, wherein the at least one comb drive comprises a stationary first electrically conductive comb having at least one comb finger and a movable second electrically conductive comb having at least one comb finger;
wherein the at least one conductive beam comprises one conductive beam connected between a first end and a second end of the movable second electrically conductive comb;
wherein the second contact is fixedly connected to the stationary first electrically conductive comb;
wherein the first contact is in contact with the one conductive beam when there is no voltage difference between the first input and the second input; and
wherein the first input is connected to the stationary first electrically conductive comb and the second input is connected to the movable second electrically conductive comb such that the voltage difference between the first input and the second input causes, by the generated electromagnetic force, the movable second electrically conductive comb to be physically drawn outward toward the stationary first electrically conductive comb and causes the one conductive beam to disconnect from the first contact.

4. The MEMS switch of claim 1, wherein the at least one comb drive comprises a first comb drive and a second comb drive;
wherein the first comb drive comprises a movable first electrically conductive comb having a first set of at least one comb finger and a stationary second electrically conductive comb having at least one comb finger;
wherein the second comb drive comprises the movable first electrically conductive comb having a second set of at least one comb finger and a stationary third electrically conductive comb having at least one comb finger;
wherein a first input is connected to the movable first electrically conductive comb, a second input is connected to the stationary second electrically conductive comb, and a third input is connected to the stationary third electrically conductive comb;
wherein the at least one conductive beam comprises a first conductive beam connected across a first side of the first set of at least one comb finger of the movable first electrically conductive comb and a first side of the second set of at least one comb finger of the movable first electrically conductive comb and a second conductive beam connected across a second side of the first set of at least one comb finger of the movable first electrically conductive comb and a second side of the second set of at least one comb finger of the movable first electrically conductive comb;
wherein the first contact is in contact with the first conductive beam and the second contact is in contact with the second conductive beam when there is no voltage difference between the first input and either of the second input or the third input; and
wherein the first contact is disconnected from the first conductive beam and the second contact is disconnected from the second conductive beam when there is a voltage difference between the first input and both of the second input and the third input which causes, by the generated electromagnetic force, the first set of at least one comb finger and the second set of at least one comb finger of the movable first electrically conductive comb to be physically drawn outward toward the stationary second electrically conductive comb and the stationary third electrically conductive comb, respectively.

5. The MEMS switch of claim 1, wherein the at least one comb drive comprises a first comb drive and a second comb drive;
wherein the first comb drive comprises a stationary first electrically conductive comb having a first set of at least one comb finger and a movable second electrically conductive comb having at least one comb finger;
wherein the second comb drive comprises the stationary first electrically conductive comb having a second set of at least one comb finger and a movable third electrically conductive comb having at least one comb finger;
wherein a first input is connected to the stationary first electrically conductive comb, a second input is connected to the movable second electrically conductive comb, and a third input is connected to the movable third electrically conductive comb;
wherein the at least one conductive beam comprises a first conductive beam connected across a first side of the movable second electrically conductive comb and a first side of the movable third electrically conductive comb and a second conductive beam connected across a second side of the movable second electrically conductive comb and a second side of the movable second electrically conductive comb;
wherein the first contact is not in contact with the first conductive beam and the second contact is not in contact with the second conductive beam when there is no voltage difference between the first input and either of the second input or the third input; and
wherein the first contact is connected to the first conductive beam and the second contact is connected to the second conductive beam when there is a voltage difference between the first input and both of the second input and the third input which causes, by the generated electromagnetic force, the movable second electrically conductive comb and the movable third electrically conductive comb to be physically drawn inward toward the stationary first electrically conductive comb, respectively.

6. The MEMS switch of claim 5, wherein the each of the first conductive beam and the second conductive beam has a shape, in an area that contacts the first contact and the second contact, respectively, comprising a flat surface, at least one raised and rounded surface, and at least one raised and pointed surface; and
wherein the each of the first contact and the second contact has a shape, in an area that contacts the first conductive beam and the second conductive beam, respectively, comprising a flat surface and a plurality of recessed and rounded surfaces.

7. The MEMS switch of claim 5, further comprising a first at least one stationary conductor abutting the movable second electrically conductive comb and a second at least one stationary conductor abutting the movable third electrically conductive comb to restrict movement of the at least one conductive beam in one axis.

8. The MEMS switch of claim 1, further comprising a first substrate on which the MEMS switch is formed and a second substrate attached to a top of the MEMS switch, wherein the first substrate and the second substrate each comprise Silicon (Si), Gallium Arsenide (GaAs), Germanium (Ge), Silicon Germanium (SiGe), Gallium Phosphide (GaP), quartz, glass, borosilicate glass, fused glass, photo-structurable glass, alumina, Gallium Nitride (GaN), a printed circuit board (PCB), Sapphire, Silicon Carbide, Aluminum Nitride (AlN), Silicon-On-Insulator (SOI), Silicon-on-Sapphire (SOS), Germanium-on-Silicon, Lithium Tantalate, Zinc Oxide, or photo definable glass, wherein Si comprises Complementary Metal Oxide Semiconductor (CMOS), Bipolar, Indium Phosphide (InP), Lithium Niobate (LiNbO₃), and Bipolar-CMOS (BiCMOS).

9. The MEMS switch of claim 2, wherein the electrostatic force (F) comprises
$$F = ( ϵ ( {hV}^{2} ) ) / g$$
wherein E is a dielectric constant of a medium in the at least one comb drive, h is a height of at least one comb finger in the stationary first electrically conductive comb, Vis the voltage difference between the first input and the second input, and gis distance between the at least one comb finger in the stationary first electrically conductive comb and the at least one comb finger in the a second electrically conductive comb.

10. The MEMS switch of claim 1, wherein the at least one conductive beam comprises a user-definable angle, wherein the user-definable angle enables motion amplification with an amplification ratio between a motion of the at least one conductive beam and a motion caused by the electrostatic force, and wherein the amplification ratio is a ratio of a motion of the at least one conductive beam to the motion caused by the electrostatic force.

11. A method of fabricating a micro-electromechanical systems (MEMS) switch, comprising:
acquiring a first substrate and a second substrate;
forming a MEMS switch on the first substrate with an amplification flexible conductive beam that moves in a direction orthogonal to a direction of electrostatic force that moves the amplification flexible conductive beam; and
attaching the second substrate to the MEMS switch.

12. The method of claim 11, wherein the MEMS switch comprises:
at least one comb drive having a first input and a second input,
at least one conductive beam connected across the at least one comb drive;
a first contact; and
a second contact,
wherein no voltage difference between the first input and the second input does not result in any movement of the MEMS switch, and
wherein a voltage difference between the first input and the second input causes an electrostatic force to be generated that causes the at least one conductive beam to move in a direction orthogonal to a direction of the electrostatic force.

13. The method of claim 12, wherein the at least one comb drive comprises a stationary first electrically conductive comb having at least one comb finger and a movable second electrically conductive comb having at least one comb finger;
wherein the at least one conductive beam comprises one conductive beam connected between a first end and a second end of the movable second electrically conductive comb;
wherein the second contact is fixedly connected to the stationary first electrically conductive comb;
wherein the first contact is not in contact with the one conductive beam when there is no voltage difference between the first input and the second input; and
wherein the first input is connected to the stationary first electrically conductive comb and the second input is connected to the movable second electrically conductive comb such that the voltage difference between the first input and the second input causes, by the generated electromagnetic force, the movable second electrically conductive comb to be physically drawn inward toward the stationary first electrically conductive comb and causes the one conductive beam to contact the first contact.

14. The method of claim 12, wherein the at least one comb drive comprises a stationary first electrically conductive comb having at least one comb finger and a movable second electrically conductive comb having at least one comb finger;
wherein the at least one conductive beam comprises one conductive beam connected between the stationary first electrically conductive comb and the movable second electrically conductive comb;
wherein the second contact is fixedly connected to the stationary first electrically conductive comb;
wherein the first contact is in contact with the one conductive beam when there is no voltage difference between the first input and the second input; and
wherein the first input is connected to the stationary first electrically conductive comb and the second input is connected to the movable second electrically conductive comb such that the voltage difference between the first input and the second input causes, by the generated electromagnetic force, the movable second electrically conductive comb to be physically drawn outward toward the stationary first electrically conductive comb and causes the one conductive beam to disconnect from the first contact.

15. The method of claim 12, wherein the at least one comb drive comprises a first comb drive and a second comb drive;
wherein the first comb drive comprises a movable first electrically conductive comb having a first set of at least one comb finger and a stationary second electrically conductive comb having at least one comb finger;
wherein the second comb drive comprises the movable first electrically conductive comb having a second set of at least one comb finger and a stationary third electrically conductive comb having at least one comb finger;
wherein a first input is connected to the movable first electrically conductive comb, a second input is connected to the stationary second electrically conductive comb, and a third input is connected to the stationary third electrically conductive comb;
wherein the at least one conductive beam comprises a first conductive beam connected across a first side of the first set of at least one comb finger of the movable first electrically conductive comb and a first side of the second set of at least one comb finger of the movable first electrically conductive comb and a second conductive beam connected across a second side of the first set of at least one comb finger of the movable first electrically conductive comb and a second side of the second set of at least one comb finger of the movable first electrically conductive comb;
wherein the first contact is in contact with the first conductive beam and the second contact is in contact with the second conductive beam when there is no voltage difference between the first input and either of the second input or the third input; and
wherein the first contact is disconnected from the first conductive beam and the second contact is disconnected from the second conductive beam when there is a voltage difference between the first input and both of the second input and the third input which causes, by the generated electromagnetic force, the first set of at least one comb finger and the second set of at least one comb finger of the movable first electrically conductive comb to be physically drawn outward toward the stationary second electrically conductive comb and the stationary third electrically conductive comb, respectively.

16. The method of claim 12, wherein the at least one comb drive comprises a first comb drive and a second comb drive;
wherein the first comb drive comprises a stationary first electrically conductive comb having a first set of at least one comb finger and a movable second electrically conductive comb having at least one comb finger;
wherein the second comb drive comprises the stationary first electrically conductive comb having a second set of at least one comb finger and a movable third electrically conductive comb having at least one comb finger;
wherein a first input is connected to the stationary first electrically conductive comb, a second input is connected to the movable second electrically conductive comb, and a third input is connected to the movable third electrically conductive comb;
wherein the at least one conductive beam comprises a first conductive beam connected across a first side of the movable second electrically conductive comb and a first side of the movable third electrically conductive comb and a second conductive beam connected across a second side of the movable second electrically conductive comb and a second side of the movable second electrically conductive comb;
wherein the first contact is not in contact with the first conductive beam and the second contact is not in contact with the second conductive beam when there is no voltage difference between the first input and either of the second input or the third input; and
wherein the first contact is connected to the first conductive beam and the second contact is connected to the second conductive beam when there is a voltage difference between the first input and both of the second input and the third input which causes, by the generated electromagnetic force, the movable second electrically conductive comb and the movable third electrically conductive comb to be physically drawn inward toward the stationary first electrically conductive comb, respectively.

17. The method of claim 16, wherein the each of the first conductive beam and the second conductive beam has a shape, in an area that contacts the first contact and the second contact, respectively, comprising a flat surface, at least one raised and rounded surface, and at least one raised and pointed surface; and
wherein the each of the first contact and the second contact has a shape, in an area that contacts the first conductive beam and the second conductive beam, respectively, comprising a flat surface and a plurality of recessed and rounded surfaces.

18. The method of claim 16, further comprising a first at least one stationary conductor abutting the movable second electrically conductive comb and a second at least one stationary conductor abutting the movable third electrically conductive comb to restrict movement of the at least one conductive beam in one axis.

19. The method of claim 11, wherein the first substrate and the second substrate each comprise Silicon (Si), Gallium Arsenide (GaAs), Germanium (Ge), Silicon Germanium (SiGe), Gallium Phosphide (GaP), quartz, glass, borosilicate glass, fused glass, photo-structurable glass, alumina, Gallium Nitride (GaN), a printed circuit board (PCB), Sapphire, Silicon Carbide, Aluminum Nitride (AlN), Silicon-On-Insulator (SOI), Silicon-on-Sapphire (SOS), Germanium-on-Silicon, Lithium Tantalate, Zinc Oxide, or photo definable glass, wherein Si comprises Complementary Metal Oxide Semiconductor (CMOS), Bipolar, Indium Phosphide (InP), Lithium Niobate (LiNbO₃), and Bipolar-CMOS (BiCMOS).

20. The method of claim 12, wherein the at least one conductive beam comprises a user-definable angle, wherein the user-definable angle enables motion amplification with an amplification ratio between a motion of the at least one conductive beam and a motion caused by the electrostatic force, and wherein the amplification ratio is a ratio of a motion of the at least one conductive beam to the motion caused by the electrostatic force.
